(19) United States
(12) Patent Application Publication
(10) Pub. No.: US 2012/0170192 A1
(43) Pub. Date: Jul. 5, 2012

(54) 3C PRODUCT WITH A DATA TRANSMISSION WIRE ACCOMMODATION STRUCTURE

(75) Inventor: HUNG-HAO CHANG, Taichung City (TW)

(73) Assignee: KIMO NATIONAL CO., LTD., Taichung City (TW)

(21) Appl. No.: 13/193,510

(22) Filed: Jul. 28, 2011

(30) Foreign Application Priority Data
Dec. 29, 2010 (TW) 099225372

(51) Int. Cl. G06F 1/16

(52) U.S. Cl. 361/679.02

(57) ABSTRACT

A 3C product with a data transmission wire accommodation structure comprises a chamber formed in a housing, the chamber has one side extending to the circuit of the 3C product and has another side formed with an inserting hole. The data transmission wire is received in the chamber with one end electrically connected to the circuit and another end connected to a terminal which is disposed in the inserting hole, so that the data transmission wire is connected to and hidden in the 3C product, making it easy to carry, store and use the data transmission wire, and also reducing production cost.

### BACKGROUND OF THE INVENTION

1. Field of the Invention

The present invention relates to a 3C product, and more particularly to a 3C product with a data transmission wire accommodation structure.

2. Description of the Prior Art

When the existing portable 3C (Computers/Communications/Consumer) products 10, such as mobile phone, digital camera, notebook, etc, are used to transmit data, as shown in FIG. 1, it requires a wire 11 with two terminals 112 at both ends thereof to be connected between the two 3C products 10, and when charging a 3 product, it also needs to use a wire 11 with two terminals 112 at both ends thereof to connect the 3 product to be charged to the power source.

Nowadays, most of people possess more than one 3C product 10, and different 3C products 10 might have different types of ports 101. For example, a digital camera and a mobile phone can't use a same wire 11 to perform data-transmission to a computer, and thus, the user has to prepare different wires 11 to fit different types of terminals 112, which is not only inconvenient but also expensive.

On the other hand, a wire body 111 of the wire 11 has a certain length and therefore is convenient for storage or to use. For example, it looks messy when the wire is plugged in a computer or power source, and it will cause dust accumulation and is inconvenient to carry when the wire is wound up.

On top of that, since the wire is separated from the 3C product, the user is likely to forget the wire when on travel or out at work, and therefore has to buy a new wire when data transmission or power charging is needed.

The present invention has arisen to mitigate and/or obviate the afore-described disadvantages.

### SUMMARY OF THE INVENTION

The primary object of the present invention is to provide a 3C product with a data transmission wire accommodation structure, wherein the data transmission wire is electrically connected to and built in the 3C product, so as to make it easy to carry, store and use the data transmission wire.

To achieve the above object, a 3C product with a data transmission wire accommodation structure a housing in which being disposed a circuit and a data transmission wire, the housing consists of a base and a cover.

The data transmission wire includes a spiral and elastic wire body which has one end connected to a terminal and has another end electrically connected to the circuit, the terminal is provided with a control protrusion.

The base is a hollow structure provided with a gap in a periphery of the base and located toward the circuit, a chamber in communication with the gap is defined adjacent to the circuit and includes a vertically-extending short portion connected to the gap and a long portion extending to the circuit. In the short portion of the chamber is provided a stopping portion which is vertically arranged and located toward the gap in such a manner that the gap and the stopping portion are located at both sides of the short portion, and the terminal is located between the gap and the stopping portion, and the wire body is inserted in the long portion and electrically connected to the circuit.

The cover is a hollow structure formed in a shape of the base and provided with a gap aligned with the gap of the base, so that the gaps of the base and the cap are combined together to define an inserting hole when the cover and the base are combined, and the terminal of the data transmission wire is engaged in the inserting hole with the control protrusion exposed out of the inserting hole.

### BRIEF DESCRIPTION OF THE DRAWINGS

FIG. 1 shows two conventional 3C products are connected by a data transmission wire;

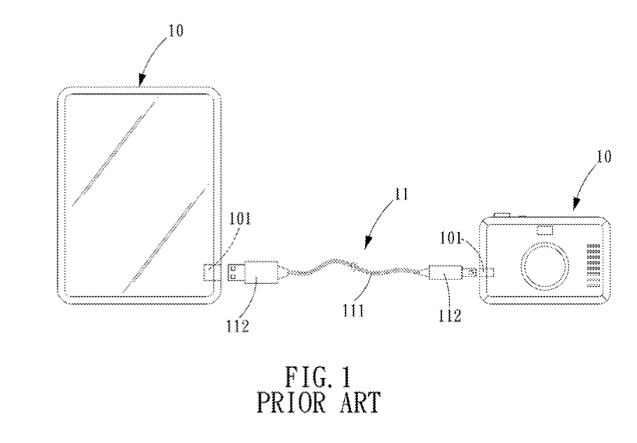

FIG. 2 is an exploded view of a 3C product with a data transmission wire accommodation structure in accordance with a preferred embodiment of the present invention;

FIG. 3 is a perspective assembly view of the 3C product with a data transmission wire accommodation structure of FIG. 2;

FIG. 4 is a plan view of the 3C product with a data transmission wire accommodation structure of FIG. 3;

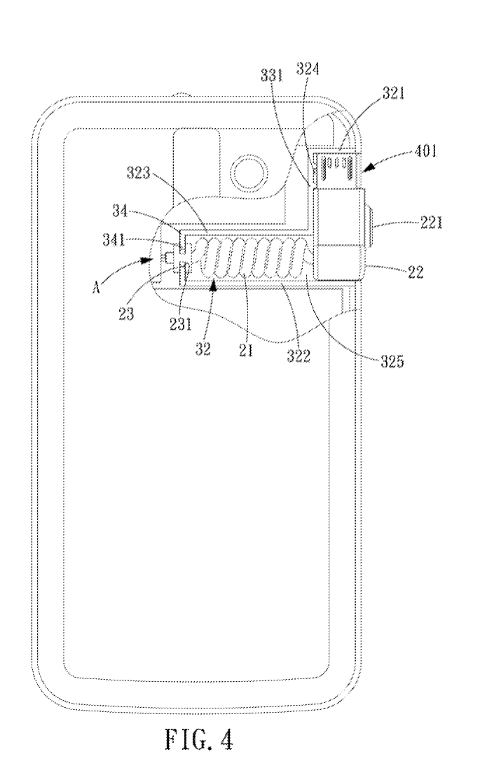

FIG. 5 shows a 3C product with a data transmission wire accommodation structure in accordance with a second preferred embodiment of the present invention;

FIG. 6 shows a 3C product with a data transmission wire accommodation structure in accordance with a third preferred embodiment of the present invention;

FIG. 7 shows a 3C product with a data transmission wire accommodation structure in accordance with a fourth preferred embodiment of the present invention;

FIG. 8 shows a 3C product with a data transmission wire accommodation structure in accordance with a fifth preferred embodiment of the present invention;

FIG. 9 shows a 3C product with a data transmission wire accommodation structure in accordance with a sixth preferred embodiment of the present invention; and

FIG. 10 shows a 3C product with a data transmission wire accommodation structure in accordance with a seventh preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

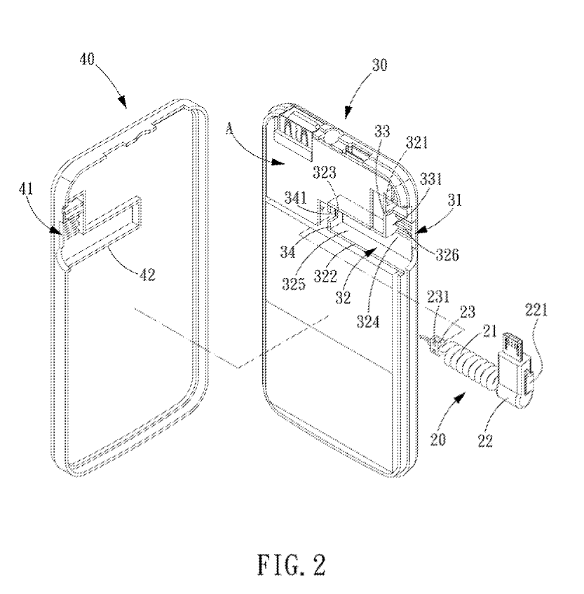

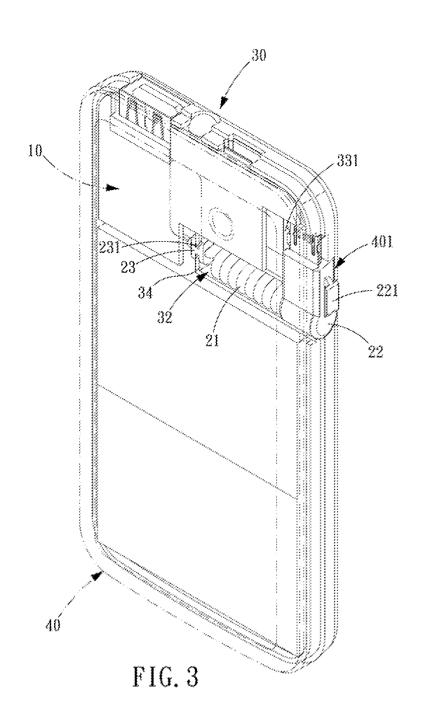

Referring to FIGS. 2 and 3, a 3C product with a data transmission wire accommodation structure in accordance with a preferred embodiment of the present invention is shown, wherein the 3C product is provided with a circuit A and a data transmission wire 20 in its housing which consists of a base 30 and a cover 40.

The data transmission wire 20 includes a wire body 21 which has one end connected to a terminal 22 to be plugged into a port of another 3C product and has another end provided with a positioning member 23 and electrically connected to the circuit A. The positioning member 23 is an H-shaped structure with a groove 231 formed in its surface. As shown in FIGS. 2 and 3, one side of the terminal 22 is connected to the wire body 21, while another side of the terminal 22 is provided with a control protrusion 221, so that the wire body 21 and the terminal 22 are connected in a reversed L-shaped fashion. The wire body 21 is elastic and spiral, which can be pulled straight to extend length and can wind up into a spiral shape automatically when not being pulled.

The base 30 is basically a hollow structure provided at its top with the circuit A, and the lower half of the base 30 is provided for accommodation of battery. A gap 31 is defined in a periphery of the base 30 and located toward the circuit A, and an L-shaped chamber 32 in communication with the gap 31 is defined adjacent to the circuit A. As shown in FIG. 3, the chamber 32 consists of a vertically-extending short portion 324 connected to the gap 31 and a long portion 325 extending horizontally to the circuit A for accommodation of the wire body 21 of the data transmission wire 20.

In the short portion 324 of the chamber 32 is provided a stopping portion 33 which is vertically arranged and located toward the gap 31 in such a manner that the gap 31 and the stopping portion 33 are located at both sides of the short portion 324, and the terminal 22 is located between the gap 31 and the stopping portion 33. At the end of the long portion 325 of the chamber 32 close to the circuit A is provided an abutting portion 34 which is vertical to the extending direction of the wire body 21 of the data transmission wire 20.

The chamber 32 is provided with two side walls 321, 322 extending from both sides of the gap 31 to the stopping portion 33 and the abutting portion 34, respectively, and a side wall 323 connected between the stopping portion 33 and the abutting portion 34, so that the side walls 321, 322, 323, the stopping portion 33 and the abutting portion 34 define a structure corresponding to the shape of the data transmission wire 20. As shown in FIG. 2, the stopping portion 33 is in the form of a board 331, and the abutting portion 34 is also a board in parallel to the stopping portion 33 and formed with a slot 341 for engaging with the positioning member 23 in such a manner that the positioning member 23 is engaged in the slot 341, and the part of the abutting portion 34 at both sides of the slot 341 are engaged in the groove 231 of the positioning member 23.

The cover 40 is a hollow structure formed in the shape of the base 30 and provided with a gap 41 aligned with the gap 31 of the base 30, so that the gaps 41, 31 define an inserting hole 401 which is shaped corresponding to the cross sectional shape of the terminal 22 when the cover 40 is combined with the base 30. As shown in FIG. 2, in the cover 40 is formed a rib 42 having the shape of the chamber 32, so that when the cover 40 and the base 30 are assembled together, the wire body 21 and the terminal 22 of the data transmission wire 20 will be received in a space defined by the rib 42, the sidewalls 321, 322, 323, the stopping portion 33 and the abutting portion 34, and the terminal 22 of the data transmission wire 20 will be engaged in the inserting hole 401.

At a bottom surface of the short portion 324 of the chamber 32 is provided an anti-skid rib 326, and the cover 40 is also provided with an anti-skid rib 426 for cooperating the anti-skid rib 326 to better position the terminal 22.

To assemble the present invention, firstly, one end of the data transmission wire 20 is inserted through the abutting portion 34 to electrically connect the circuit A of the 3C product, the wire body 21 is inserted in the chamber 32, and then the terminal 22 is engaged in the inserting hole 401 with the control protrusion 221 exposed outward.

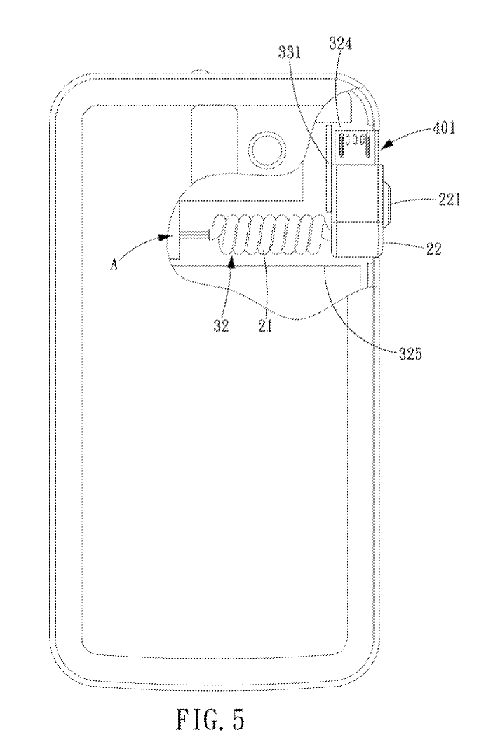

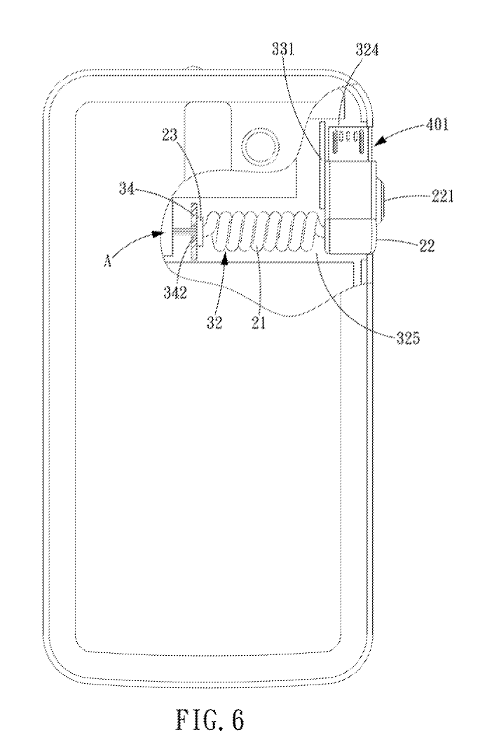

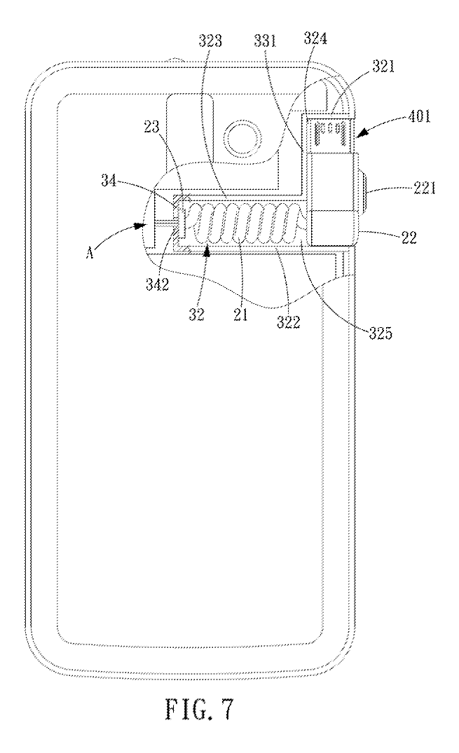

Referring then to FIGS. 5-7, which show different embodiments of the L-shaped chamber 32 consisted of the long and short portions 325, 324. In FIG. 5, only in the short portion 324 of the chamber 32 is provided the stopping portion 33 to restrict the terminal 22 between the gap 31 and the stopping portion 33. In FIG. 6, in addition to the stopping portion 33, in the chamber 32 is further provided the abutting portion 34, the positioning member 23 is sheet-like without groove and larger than the slot 341 of the abutting portion 34, the wire body 21 is inserted through the slot 341 and connected to the circuit A, and the positioning member 23 is abutted against the abutting portion 34. In FIG. 7, the chamber 32 is defined by the sidewalls 321, 322, 323, the stopping portion 33 and the abutting portion 34.

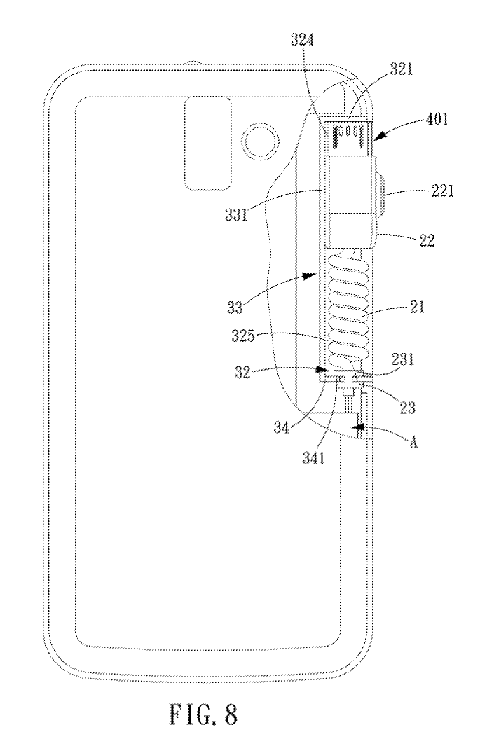

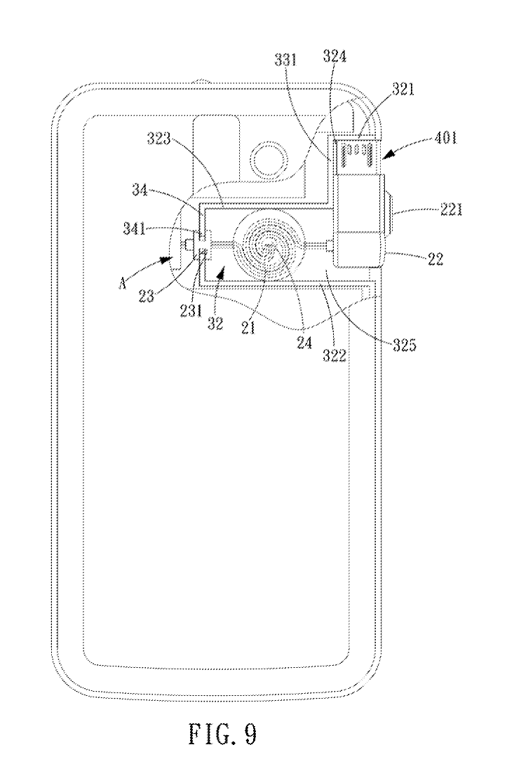

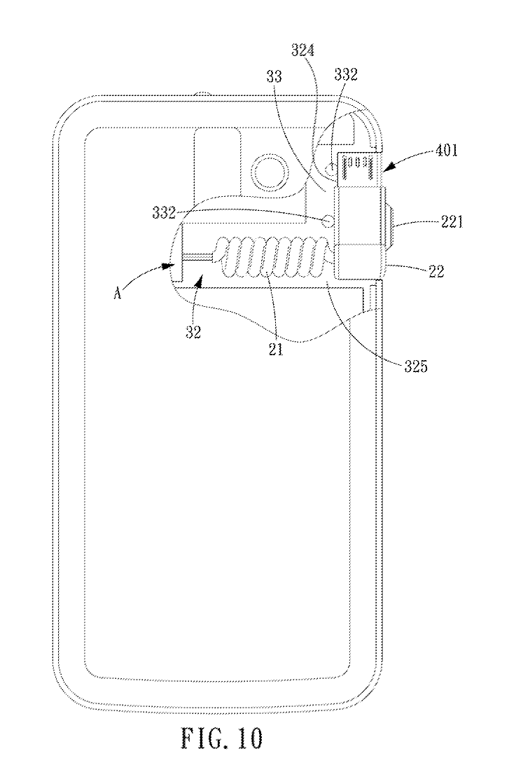

Referring then to FIGS. 8-10, which show other embodiments of the present invention, in FIG. 8, the wire body 21 and the terminal 22 are connected in a straight line, and the chamber 32 is rectangular-shaped instead of L-shaped, and the stopping portion 33 is in the form of a board 331. In FIG. 9, the wire body 21 of the data transmission wire 20 is a straight line winding around a roller 24 which can wind up the wire body 21 automatically. In FIG. 10, the stopping portion 33 takes the form of two pins 332 which are formed at to stop against the terminal 22.

As shown in FIG. 3, the user can pull the terminal 22 out of the inserting hole 401 by gripping the control protrusion 221, and can put the terminal 22 back into the inserting hole 401 after use, the data transmission wire 20 will automatically retract back due to the elasticity of the spiral structure. Hence, the present invention makes it easier to store, carry and use the data transmission wire 20.

On the other hand, as compared to the fact that the conventional wire must be provided with two terminals, plus the 3C should also have a port to fit the terminals, the data transmission wire 20 of the present invention is electrically connected to the circuit A of the 3C product and can directly retract back in the housing of the 3C product after use. The data transmission wire 20 can be used both for charging and data transmission purposes.

While we have shown and described various embodiments in accordance with the present invention, it is clear to those skilled in the art that further embodiments may be made without departing from the scope of the present invention.

What is claimed is:

1. A 3C product with a data transmission wire accommodation structure comprising a housing in which being disposed a circuit and a data transmission wire, the housing consisting of a base and a cover;
the data transmission wire including a wire body which has one end connected to a terminal and has another end electrically connected to the circuit;
the base being a hollow structure provided with a gap in a periphery of the base and located toward the circuit, a chamber in communication with the gap being defined adjacent to the circuit and including a vertically-extending short portion connected to the gap and a long portion extending to the circuit, in the short portion of the chamber being provided a stopping portion which is vertically arranged and located toward the gap in such a manner that the gap and the stopping portion are located at both sides of the short portion, and the terminal is located between the gap and the stopping portion, and the wire body being inserted in the long portion and electrically connected to the circuit;
the cover is a hollow structure formed in a shape of the base and provided with a gap aligned with the gap of the base, so that the gaps of the base and the cap are combined together to define an inserting hole when the cover and the base are combined, and the terminal of the data transmission wire is engaged in the inserting hole with the terminal exposed out of the inserting hole.

2. The 3C product with a data transmission wire accommodation structure as claimed in claim 1, wherein the another end of the wire body is provided with a positioning member, at one end of the long portion of the chamber close to the circuit is provided an abutting portion which is vertical to an extending direction of the wire body of the data transmission wire, the wire body is inserted in the chamber and through the abutting portion to electrically connect the circuit, and the positioning member is abutted against the abutting portion.

3. The 3C product with a data transmission wire accommodation structure as claimed in claim 2, wherein the positioning member is an H-shaped structure with a groove formed in its surface, the abutting portion is formed with a slot for engaging with the positioning member in such a manner that the positioning member is engaged in the slot, and parts of the abutting portion at both sides of the slot are engaged in the groove of the positioning member.

4. The 3C product with a data transmission wire accommodation structure as claimed in claim 2, wherein the positioning member is sheet-like without groove and larger than the slot of the abutting portion, the wire body is inserted through the slot and connected to the circuit, and the positioning member is abutted against the abutting portion.

5. The 3C product with a data transmission wire accommodation structure as claimed in claim 1, wherein the wire body of the data transmission wire is a straight line winding around a roller.

6. The 3C product with a data transmission wire accommodation structure as claimed in claim 1, wherein the wire body of the data transmission wire is helical and elastic.

7. The 3C product with a data transmission wire accommodation structure as claimed in claim 1, wherein the terminal is provided with a control protrusion, the wire body and the terminal are connected in a reversed L-shaped fashion, the long portion extends horizontally to the circuit, the long portion of the chamber is provided with an abutting portion which is vertical to an extending direction of the wire body of the data transmission wire, the chamber is provided with two side walls extending from both sides of the gap to the stopping portion and the abutting portion, respectively, and a side wall connected between the stopping portion and the abutting portion, so that the three side walls, the stopping portion and the abutting portion define a space corresponding to the shape of the data transmission wire.

8. The 3C product with a data transmission wire accommodation structure as claimed in claim 1, wherein the stopping portion is a board.

9. The 3C product with a data transmission wire accommodation structure as claimed in claim 1, wherein two pins are formed at the abutting portion to stop against the terminal.

10. The 3C product with a data transmission wire accommodation structure as claimed in claim 1, wherein the wire body and the terminal are connected in a straight line, and the chamber is rectangular-shaped.

11. The 3C product with a data transmission wire accommodation structure as claimed in claim 1, wherein in the cover is formed a rib corresponding to a shape of the chamber, so that when the cover and the base are assembled together, the wire body and the terminal of the data transmission wire are received in a space defined by the rib and the chamber, and the control protrusion of the terminal is exposed out of the inserting hole.
